(19) United States
(12) Patent Application Publication
(10) Pub. No.: US 2004/0090779 A1
(43) Pub. Date: May 13, 2004

(54) Light mixing led and manufacturing method thereof

(76) Inventors: Chen Ou, Hsin-Chu City (TW); Chen-Ke Hsu, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/412,306

(22) Filed: Apr. 14, 2003

(30) Foreign Application Priority Data
Apr. 15, 2002 (TW) 091108031

(51) Int. Cl. F21V 9/00

(52) U.S. Cl. 362/231; 362/800

(57) ABSTRACT

A light mixing LED and manufacturing method thereof, wherein the manufacturing method comprises the steps of forming, on an insulation substrate, a first quantum well active layer, a tunnelable barrier layer, a second quantum well active layer, a first electrode, a second electrode. Under the condition that the wavelengths of the light from the first and second quantum well active layers are predetermined, as the thickness of the tunnelable barrier is changed, the tunneling probability of the conductive carrier through the tunnelable barrier can be changed and consequently lead to the numbers of the conductive carriers flowing into and taking part in the electro-photo energy conversion in the first active layer and in the second active layer are different. Therefore a mixed light of specific chromaticity can be obtained by modulating the width of the tunnelable barrier.

### BACKGROUND OF THE INVENTION

1. Field of the Invention

The present invention relates to a light emitting diode (LED), and more particularly to a light mixing white LED and manufacturing method thereof.

2. Description of the Prior Art

Light emitting diodes (LEDs) are employed in a wide variety of applications including optical displays, traffic lights, data storage apparatuses, communication devices, illumination apparatuses, and medical treatment equipment. Among varieties of LEDs, white ones are the most important and in great potential demand. Fluorescent tubes or lamps that are widely in use could be replaced by white LEDs if the manufacturing cost thereof can be reduced and the life thereof can be prolonged.

R.O.C. patent no. 100,177 discloses a white LED and the manufacturing method thereof, wherein the white LED has two or more energy gaps for photoelectric conversion in such way that it can emit white light in itself. This prior art manufacturing method comprises providing a multiple quantum well structure in their device. When the quantum-well structure was grown, the temperature, pressure, flowrate of ammonia, proportion of the carrier gas can be tuned and/or impurities such as magnesium and/or silicon can be added in a predetermined parametric range so that the spectrum of light from the multiple quantum well includes different primary emitting peaks with different wavelengths. White light can thus be formed by a spectrum having these two or three primary emitting peaks.

However, in practice, to achieve ideal chromaticity, the relative intensities of the primary emitting peaks as well as a combination of primary emitting peaks having appropriate wavelengths respectively have to be considered. A disadvantage of the above-mentioned prior art manufacturing method lies in that it only allows the wavelengths of the primary emitting peaks to be adjusted, but the relative intensities of the primary emitting peaks cannot be effectively controlled. This results in the difficulty of obtaining desirable chromaticity of mixed light and a highly complex manufacturing process.

In contemplating how to effectively control the relative intensities of these primary emitting peaks of different wavelengths for achieving desirable chromaticity of mixed light from a white LED by a manufacturing method of reduced complexity, the inventors of the present invention got a concept that the relative intensities of two primary emitting peaks of different wavelengths can be changed to effectively achieve desirable chromaticity of the mixed light by forming a barrier with a thickness can be tunneled by carrier (below we call it a “tunnelable barrier”) between a first active quantum layer and a second active quantum layer in the multiple quantum well, wherein the width of the tunnelable barrier can be modulated to adjust the probability of conductive carriers tunneling through the tunnelable barrier so that the ratio between the conductive carriers participating photoelectric conversion in the first active quantum layer and those in the second active quantum layer can be adjusted with no need of changing the composition or structure of the first and second active quantum layers (i.e. the wavelengths of the two corresponding primary emitting peaks remaining essentially unchanged). When a predetermined voltage is applied to a white LED through the first and second electrodes thereof, the number of conductive carriers entering the first active quantum layer and the number of conductive carriers entering the second active quantum layer are different due to the limitation of probability that conductive carriers tunnel through the tunnelable barrier. Thereby, the first active quantum layer emits a light of the first intensity in the first wavelength range, and the second active quantum layer emits a light of the second intensity in the second wavelength range. The light of the first emitting peak with the first intensity and wavelength and the light of the second emitting peak with the second intensity and wavelength mix together and thereby generate mixed light of a specific chromaticity. In the case that a different width of the tunnelable barrier is adopted, a different ratio between the intensity of light of the first emitting peak with the first wavelength and that of the second emitting peak with second wavelength range can be obtained and thus a mixed light of another specific chromaticity can be obtained. More specifically, the present invention can be used not only for improving the manufacturing method of the above-mentioned prior art white LED but also for manufacturing a light mixing LED emitting light of a specific chromaticity, for example, a azure color, a light green color, or a pink color.

### SUMMARY OF THE INVENTION

To avoid the aforementioned disadvantage of the prior art, an object of the invention is to provide a light mixing LED, wherein a tunnelable barrier is provided between two active quantum layers so that the light mixing LED can emit, in itself, mixed light of specific chromaticity. To change chromaticity of mixed light emitted from the light mixing LED, only the width of the tunnelable barrier has to be changed. Thereby, a method of reduced complexity for manufacturing a light mixing LED can be achieved.

A light mixing LED in accordance with a preferred embodiment of the invention comprises an insulation substrate; a buffer layer formed on the insulation substrate; a cladding layer of a first conductive type form on the buffer layer; the upper surface of the cladding layer of the first conductive type comprising a first surface area and a second surface area; a first quantum well active layer formed on the first surface area; a tunnelable barrier layer formed on the first quantum well active layer; a second quantum well active layer formed on the tunnelable barrier layer; a cladding layer of a second conductive type formed on the second quantum well active layer; a contact layer of the second conductive type formed on the cladding layer of the second conductive type; an transparency ohmic contact layer formed on the contact layer of the second conductive type;

an electrode of the second conductive type formed on the transparency ohmic contact layer of the second conductive type; an ohmic contact layer of the first conductive type formed on the second surface area of the cladding layer of the first conductive type; and an electrode of the first conductive type formed on the ohmic contact layer of the first conductive type.

A manufacturing method of the light mixing LED comprises the steps of forming, one by on in order on an insulation substrate, a buffer layer, a cladding layer of a first conductive type, a first quantum well active layer, a tunnelable barrier layer, a second quantum well active layer, a cladding layer of a second conductive type, a contact layer of the second conductive type, a transparency ohmic contact layer of the second conductive type, an electrode of the second conductive type; suitably etching the stack formed in the prior step to form an exposed area of the cladding layer of the first conductive type; forming an ohmic contact layer of the first conductive type on the exposed area of the cladding layer of the first conductive type; and forming an electrode of the first conductive type on the ohmic contact layer of the first conductive type.

### BRIEF DESCRIPTION OF THE DRAWINGS

FIG. 1 is a schematic diagram illustrating the basic principle of the present invention;

FIG. 2 is a schematic diagram illustrating a light mixing LED in accordance with a preferred embodiment of the invention; and

FIG. 3 is a schematic diagram illustrating a light mixing LED in accordance with another preferred embodiment of the invention.

### DETAILED DESCRIPTION OF THE INVENTION

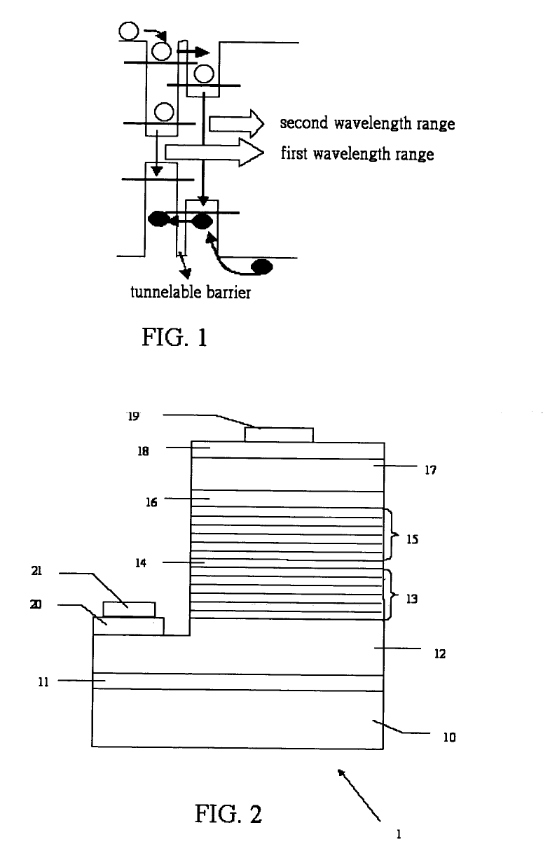

Firstly, the basic principle of the invention is described herein. A first quantum well active layer of InGaN, which can emit light in a first wavelength range, can be formed as in the prior art. In the case that a second quantum well active layer of InGaN, which can emit light in a second wavelength range, is formed and a tunnelable barrier is formed between the first and second quantum well active layers, as shown in FIG. 1, the probability of tunneling through the tunnelable barrier by conductive carriers can be modulated by adjusting the width of the tunnelable barrier. When a predetermined voltage is applied over the first and second quantum well active layers, the number of the conductive carriers flowing into and taking part in the electro-photo energy conversion in the first quantum well active layer is differed from that in the second quantum well active layer. Thereby, the first quantum well active layer emits light of the first intensity and in the first wavelength range, and the second quantum well active layer emits light of the second intensity and in the second wavelength range. Mixed light of specific chromaticity can be obtained by mixing light of the first active layer and that of the second active layer.

A change in chromaticity of mixed light from a light mixing LED in accordance with the invention can be achieved by changing the width of the tunnelable barrier in manufacturing an LED so that ratio between the conductive carriers participating the electro-photo energy conversion in the first quantum well active layer and that in the second quantum well active layer is changed and consequently the ratio between the intensity of light in the first wavelength range and that in the second wavelength range is changed.

Of course, the quantum well active layer structure in accordance with the invention is not limited to two quantum well active layers and it may comprise more than two quantum well active layers. Moreover, the light mixing principle in accordance with the invention can be applied not only to manufacturing single-chip white light emitting LEDs but also to manufacturing single-chip LEDs that emit light of a specific color, such as azure, light green or pink.

A light mixing LED 1 in accordance with a preferred embodiment of the invention, as shown in FIG. 2, comprises a selected insulation substrate 10; a buffer layer 11 formed on the insulation substrate 10; a cladding layer 12 of a first conductive type formed on the buffer layer 11, the upper surface of the cladding layer 12 of the first conductive type comprising a first surface area and a second surface area; a first quantum well active layer 13 formed on the first surface area; a tunnelable barrier layer 14 formed on the first quantum well active layer 13; a second quantum well active layer 15 formed on the tunnelable barrier layer 14; a cladding layer 16 of a second conductive type formed on the second quantum well active layer 15; a contact layer 17 of the second conduction-type formed on the cladding layer 16 of the second conductive type; an ohmic contact layer 18 of the second conductive type formed on the contact layer 17 of the second conductive type; an electrode 19 of the second conductive type formed on the ohmic contact layer 18 of the second conductive type; an ohmic contact layer 20 of the first conductive type formed on the second surface area of the cladding layer 12 of the first conductive type; and an electrode 21 of the first conductive type formed on the ohmic contact layer 20 of the first conduction-type.

A manufacturing method of the light mixing LED 1 comprises the steps of forming, one by on in order on an insulation substrate 10, a buffer layer 11, a cladding layer 12 of a first conductive type, a first quantum well active layer 13, a tunnelable barrier layer 14, a second quantum well active layer 15, a cladding layer 16 of a second conductive type, a contact layer 17 of the second conductive type, an ohmic contact layer 18 of the second conductive type, an electrode 19 of the second conductive type; suitably etching the stack formed in the prior step to form an exposed area of the cladding layer 12 of the first conductive type; forming an ohmic contact layer 20 of the first conductive type on the exposed area of the cladding layer 12 of the first conductive type; and forming an electrode 21 of the first conductive type on the ohmic contact layer 20 of the first conductive type.

A light mixing white LED (not shown) in accordance with another preferred embodiment of the invention is similar, in structure, to that shown in FIG. 2 and is featured in that the first quantum well active layer 13 can emit yellow light having a primary peak wave length of 570 nm and the second quantum well active layer 15 can emit blue light having a primary peak wave length of 460 nm. In the case that the tunnelable barrier layer 14 has a thickness of 3.2 nm, the mixed light emitted by the white LED is within a small white light range on the chromaticity chart centered at X=˜0.3 and y=˜0.3. However, if the thickness of the tunnelable barrier layer 14 is reduced to 2.8 nm, the mixed light will be within a small warm (yellowish) white light range on the chromaticity chart centered at X=˜0.34 and y=˜0.38. Moreover, if the thickness of the tunnelable barrier layer 14 is increased to 3.8 nm, the mixed light will be within a small cool (bluish) white light range on the chromaticity chart centered at X=˜0.26 and y=˜0.24.

The insulation substrate 10 comprises a material selected from a group consisting of sapphire, LiGaO₂, and LiAlO₂. The cladding layer 12 of the first conductive type comprises a material selected from a group consisting of AlN, GaN, AlGaN, InGaN, and AlInGaN. The first quantum well active layer 13 comprises a material selected from a group consisting of GaN, InGaN, and AlInGaN. The second quantum well active layer 15 comprises a material selected from a group consisting of GaN, InGaN, and AlInGaN. The tunnelable barrier layer 14 comprises a material selected from a group consisting of AlN, InN, GaN, InGaN, and AlGaN. The cladding layer 16 of the second conductive type comprises a material selected from a group consisting of AlN, GaN, AlGaN, InGaN, and AlInGaN. The contact layer 17 of the second conductive type comprises a material selected from a group consisting of GaN, InGaN, and AlGaN. The ohmic contact layer 18 of the second conductive type comprises a material selected from a group consisting of Ni/Au, NiO/Au, Ta/Au, TiWN, indiumtinoxide, cadmiumtinoxide, antimony tin oxide, zinc oxide, and zinc tin oxide. The electrode 21 of the first conductive type or the electrode 19 of the second conductive type comprises a material selected from a group consisting of Al, Al/Ti, Au, Ni/Au, Pt/Au, Pd/Au, Cr/Au, Ta/Ti, TiW, Pt/Ni/Au, Mo/Au, and Co/Au. The ohmic contact layer 20 of the first conductive type comprises a material selected from a group consisting of Al, Ti, Ti/Al, Cr/Al, Ti/Au, Cr/Au, Au/Ge, TiW, WSi, indium tin oxide, cadmium tin oxide, antimony tin oxide, zinc oxide, and zinc tin oxide.

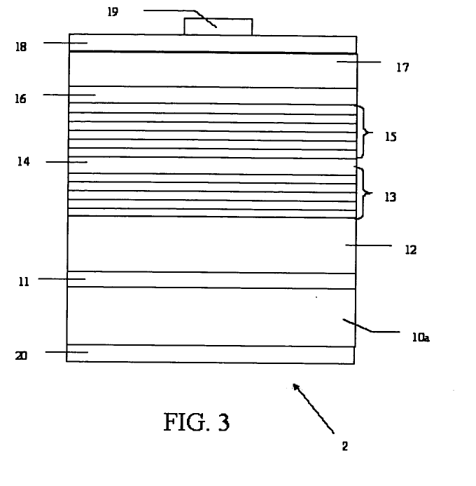

Referring to FIG. 3, A light mixing white LED 2 in accordance with yet another preferred embodiment of the invention is similar, in structure, to that shown in FIG. 2 except that compound semiconductor layers 11 to 17 are epitaxially formed on a first primary surface of a substrate 10a of a first conductive type and an ohmic contact layer 20 of the first conductive type is in contact with another primary surface of the substrate 10a. Therefore, there is no need to carry out an etching process, as aforementioned, after forming layers 11 to 18. The substrate 10a of the first conductive type comprises a material selected from a group consisting of GaN, Sic, Si, Ge, AlN, GaAs, InP, and GaP.

It can be understood from the above detailed description that by adjusting the tunnelable barrier layer between the two quantum well active layers in a light mixing LED in accordance with the invention, a single chip of the light mixing LED can emit mixed light of a predetermined chromaticity. Thereby, the aforementioned objects of the invention can be achieved.

Although the preferred embodiments of the invention have been illustrated and described in the above, it will be obvious to those skilled in the art that various modifications may be made without departing from the scope and spirit of the invention defined by the appended claims. For example, the multiple quantum well active layers of the preferred embodiments are not limited to two layers. They can be replaced by more than two multiple quantum well active layers, two single quantum well active layers, two hetero-structure layers, or two pure InGaN active layers. In addition, the LEDs in accordance with the invention can be of flip-chip type. Moreover, the structure and principle of the invention can be used for generating a mixed light of another color. Furthermore, the InGaN multiple quantum well active layers in accordance with the invention can be replaced by AlInGaP compound semiconductor layers often used in conventional LEDs without departing from the spirit and scope of the invention.

We claim:

1. A manufacturing method of a light mixing LED comprising:
providing a substrate;
forming a semiconductor stack over said substrate, the semiconductor stack comprising at lease a first active layer, a tunnelable barrier, and a second active layer,
wherein said tunnelable barrier is positioned between said first active layer and said second active layer and the thickness of said tunnelable barrier is adjustably determined so that when a current passes through said semiconductor stack, said first active layer emits a light of a first predetermined intensity in the first wavelength range and said second active layer emits a light of a second predetermined intensity in the second wavelength range, and a mixed light of a predetermined chromaticity can be obtained by mixing the light of the first active layer and the light of the second active layer.

2. A manufacturing method of a light mixing LED according to claim 1, wherein the first active layer comprises a quantum well structure.

3. A manufacturing method of a light mixing LED according to claim 2, wherein said quantum well structure comprises r1 quantum wells and r1>1.

4. A manufacturing method of a light mixing LED according to claim 1, wherein the second active layer comprises a quantum well structure.

5. A manufacturing method of a light mixing LED according to claim 4, wherein said quantum well structure comprises r2 quantum wells and r2>1.

6. A manufacturing method of a light mixing LED according to claim 1, wherein said mixed light is white light.

7. A light mixing LED comprising:
a substrate;
a semiconductor stack formed over said substrate, the semiconductor stack comprising at lease a first active layer, a tunnelable barrier, and a second active layer,
wherein said tunnelable barrier is positioned between said first active layer and said second active layer and the thickness of said tunnelable barrier is adjustably determined so that when a current passes through said semiconductor stack, said first active layer emits a light of a first predetermined intensity in the first wavelength range and said second active layer emits a light of a second predetermined intensity in the second wavelength range, and a mixed light of a predetermined chromaticity can be obtained by mixing the light of the first active layer and the light of the second active layer.

8. A light mixing LED according to claim 7, wherein the first active layer comprises a quantum well structure.

9. A light mixing LED according to claim 8, wherein said quantum well structure comprises r6 quantum wells and r6>1.

10. A light mixing LED according to claim 7, wherein the second active layer comprises a quantum well structure.

11. A light mixing LED according to claim 10, wherein said quantum well structure comprises r7 quantum wells and r7>1.

12. A light mixing LED according to claim 7, wherein said mixed light is white light.

13. A light mixing LED comprising:
a conductive substrate having a first primary surface and a second primary surface;
an ohmic contact layer of a first conductive type in electrical contact with the first primary surface of the conductive substrate;
a buffer layer formed over the second primary surface of the conductive substrate;
a first cladding layer of the first conductive type formed over the buffer layer;
a first active layer formed over the first cladding layer;
a first tunnelable barrier formed over the first active layer;
a second active layer formed over the first tunnelable barrier;
a second cladding layer of a second conductive type formed over the second active layer;
a contact layer of a second conductive type formed over the second cladding layer;
an ohmic contact layer formed over the contact layer of the second conductive type; and
an electrode formed over the ohmic contact layer.

14. A light mixing LED according to claim 13, wherein the thickness of the first tunnelable barrier is between 0.5 nm to 8 nm.

15. A light mixing LED according to claim 13, further comprising a third active layer formed between the second active layer and the second cladding layer.

16. A light mixing LED according to claim 15, further comprising a second tunnelable barrier formed between the second active layer and the third active layer.

17. A light mixing LED according to claim 15, further comprising a plurality of active layers formed between the third active layer and the second cladding layer.

18. A light mixing LED according to claim 13, further comprising a third active layer formed between the first cladding layer and the first active layer.

19. A light mixing LED according to claim 18, further comprising a second tunnelable barrier formed between the third active layer and the first active layer.

20. A light mixing LED according to claim 18, further comprising a plurality of active layers formed between the first cladding layer and the third active layer.
